(19) United States
(12) Patent Application Publication
(10) Pub. No.: US 2009/0322781 A1
(43) Pub. Date: Dec. 31, 2009

(54) Anti-aliasing techniques for image processing

(76) Inventors: Mikhail Letavin, Nizhegorodsky Region (RU); Alexei Soupikov, Nizhny Novgorod (RU); Maxim Y. Shevtsov, Nizhny Novgorod (RU)

Correspondence Address: TROP, PRUNER & HU, P.C., 1616 S. VOSS RD., SUITE 750, HOUSTON, TX, 77057-2631, US

(21) Appl. No.: 12/215,859

(22) Filed: Jun. 30, 2008

(51) Int. Cl. G09G 5/00

(52) U.S. Cl. 345/611

(57) ABSTRACT

Samples may be taken to determine illumination gradients across subdivided areas of a pixel to determine which pixels are more likely to experience aliasing. More samples are then taken in the regions that are more likely to experience aliasing. The determination of those regions that are more likely to experience aliasing may be completed automatically.

### BACKGROUND

This relates generally to image processing and, particularly, to anti-aliasing techniques.

Aliasing is the creation of stair-stepped edges in computer generated images. Aliasing may appear as defects at geometry edges, such as shadow or reflection boundaries.

Anti-aliasing techniques analyze the image data and attempt to correct or smooth the aliasing defects. This is done by computing a number of samples on each pixel. Adaptive anti-aliasing determines the artifact probability from a small number of samples and develops more samples in areas where the probability of artifacts is higher.

### BRIEF DESCRIPTION OF THE DRAWINGS

FIG. 1 is a flow chart for one embodiment;

FIG. 2A shows a four way primary pattern for one image block in accordance with one embodiment of the present invention;

FIG. 2B shows a sixteen way primary pattern;

FIG. 3 shows a secondary pattern in accordance with one embodiment of the present invention;

FIG. 4 shows the stratification of a pixel in accordance with one embodiment of the present invention; and

FIG. 5 is a system depiction in accordance with one embodiment of the present invention.

### DETAILED DESCRIPTION

In accordance with some embodiments of the present invention, an adaptive anti-aliasing technique involves processing rectangular image blocks independently with separate threads. The block size may be selected for a particular type of processing, such as symmetric multiprocessing (SMP), including single instruction multiple data (SIMD) capabilities. For example, some SIMD processing capabilities may work with blocks of four samples or blocks of sixteen. The number of samples that the processor works with determines the block size in accordance with some embodiments.

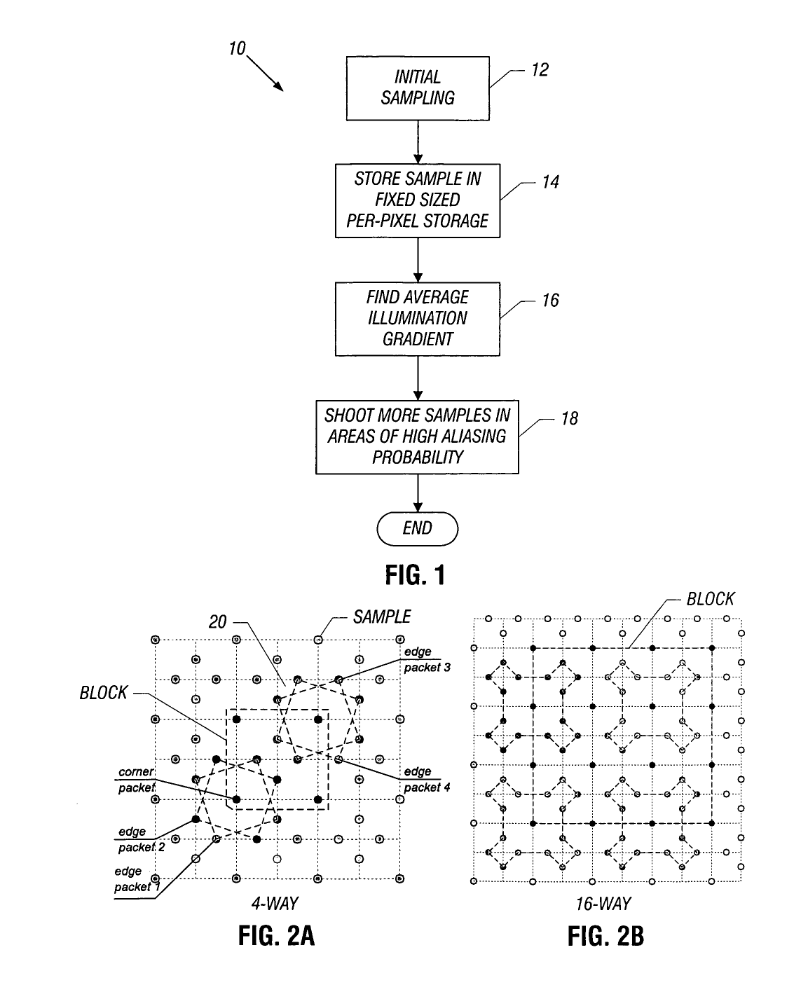

In a first stage of anti-aliasing, called initial sampling, shown in block 12 in FIG. 1, a sparse stratified sample pattern is developed with a strata step equal to or less than half the size of a pixel. A “sample” is a point on a pixel, such as an edge or corner, whose illumination characteristics are computed. By the term “sparse,” it is intended to refer to a sample density of 1.25 to 2 samples per pixel. Thus, the sample density may be kept relatively low to reduce computation costs since each sample costs some computing time. A “strata” is an equal horizontal, vertical, or diagonal portion of a pixel. A “stratified sample pattern” is where the samples are taken so that each strata has only one sample. For example, there may be one sample for each of two horizontal, vertical, or diagonal direction strata.

Thus, referring to FIG. 4, a pixel 20 may be stratified into two vertical stratas on either side of the vertical axis V, two diagonal stratas on either side of the diagonal axis D, and two horizontal stratas on either side of the horizontal axis H. Thus, the sample V on an upper horizontal edge of the pixel provides information for vertical strata, the sample H on the left vertical edge of the pixel provides information for the upper and lower horizontally disposed strata, and the sample D, on the diagonal D, provides the information for the diagonal stratas on either side of the diagonal D. Thus, in some embodiments, the samples may be taken at pixel corners and edges, as depicted in FIG. 4.

The resulting samples may be stored in a pre-allocated buffer with fixed size per pixel storage, as indicated in block 14. To decrease the computation cost of the first stage, a sampling pattern, described herein as the “primary pattern,” shares as many samples as possible with adjacent strata, for example, by taking samples at pixel corners and edges.

In this first stage, a color value at every sample position is computed and stored in the buffer, as indicated in FIG. 1, block 14. By the end of the first stage there may be a number of computed color values in this buffer, equal to the image width, times the image height, times the number of samples per pixel.

To achieve the best possible SIMD utilization and ray packet coherency (when either or both are used), samples may be arranged in SIMD packets, as depicted in FIG. 2. Different sampling patterns may be used, depending on the particular computational or architectural requirements. For example, if the SIMD processing has a width of four or processes four sets of data at the same time, the approach of FIG. 2A may be utilized. As another example, if the SIMD processing is done on sixteen parallel sets of data, because the processor has a width of sixteen, sixteen way sampling may be used, as indicated in FIG. 2B.

Thus, referring to the labeled “block” of four pixels in FIG. 2A, wherein each of the smallest rectangles is a pixel, three samples are taken for each pixel. A block is a group of pixels, such as four or sixteen pixels, to analyze as an atomic unit by a separate thread. One of the samples is in the corner and the other two samples are on opposed edges.

A “packet” is made up of four similarly situated samples, in one embodiment. For example, in FIG. 2A, the edge packet one is composed of a square set of edge pixels, from a different edge, from four adjacent pixels. Edge packet two is made up of another set of four different edge samples from the same four pixels. Edge packet number four is similarly made up of four edge samples of four different pixels 20 and edge packet three is made up of four edge samples from the same set of pixels as edge packet four. The labeled block at the center, composed of four pixels, has four samples taken at the pixel corners.

The sixteen pixel sample is shown within the dotted lines marked as block in FIG. 2B. The corresponding samples are indicated for a sixteen pixel sample size.

The primary samples are the samples used to determine the probability of aliasing. The secondary samples are the samples used for supersampling where aliasing is more likely. Supersampling is the more intensive sampling, using both of the primary and secondary samples.

The second stage, called image analysis, involves finding an average illumination gradient (block 16, FIG. 1) using data computed at the initial sampling stage. For every image block and every pixel within the block, the absolute values of mutual illumination differences, called gradients, are accumulated between primary samples contributing to that pixel. Thus, if all three differences between samples in adjacent stratas are calculated and this is repeated for all image pixels, there are a large number of gradients or differences that are determined. The illumination may be a vector of values consisting of color components, such as RGB color components or spectral bins. This accumulation results in a single value that may be a vector, which is the integral of absolute gradients of the color/spectral components over the whole image. That summed absolute difference is normalized by a number of gradients that are computed and result in an average gradient magnitude.

Each pixel, in one embodiment, may be sampled with two edge samples and one corner sample, the edge samples defining two vertical or horizontal, adjacent portions of the pixel, called strata, and the corner pixel defining two adjacent, diagonal strata. If the illumination differences or gradients between these adjacent strata are determined, a set of differences can be derived and the average of those differences is a measure of the color variation within the image. The computed average gradient magnitude serves as a supersampling threshold in the following stage. In other words, the computed average gradient magnitude provides a threshold to determine if more samples are needed (i.e. supersampling) because the possibility of aliasing is much higher. Then, more samples (i.e. secondary samples) can be automatically generated in areas where aliasing effects are greatest.

For typically rendered images, pixels with high color variation create an aliasing effect and will have some of the color gradients between their samples that are much higher than average. These pixels need to be supersampled more densely to suppress aliasing. Pixels that have low color variation generally do not cause the aliasing and so they do not need to be supersampled and computing time can be saved by avoiding supersampling those pixels.

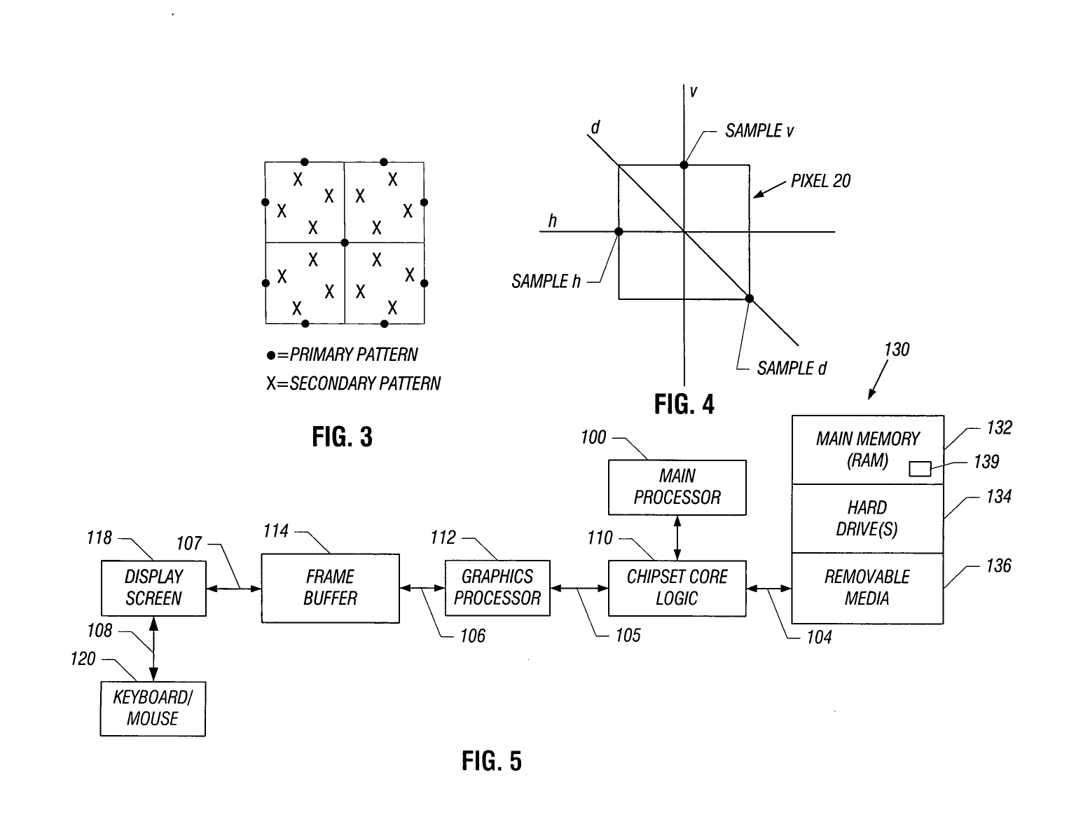

In the third stage, called image enhancing, more samples are taken in areas where aliasing effects were determined to be in excess of the threshold, as indicated in FIG. 1 at block 18. For every image block, if one of the gradients of any pixel in the block is higher than the supersampling threshold, samples are then taken from the secondary pattern, shown in FIG. 3.

In FIG. 3, in each square block, four additional samples, marked by Xs, are taken. These four additional samples are effective to further stratify the pixel into five horizontal, five vertical, and five diagonal strata of equal size. More or less secondary pattern samples can be taken in some embodiments.

The effect of the combination of the secondary pattern and the primary pattern sampling is a highly stratified pattern that may maximize usage of information brought by samples from both patterns. Thus, rendering can be sped up by skipping the computation required for higher sampling of pixels that will not contribute to aliasing. Since calculations may be performed using SIMD vectors, color sampling may be done and decisions may be made on a block level. For example, blocks may be sets of 4×4 or 8×8 pixel blocks, depending on the vector size of a given graphics processor.

The threshold can be computed in many different ways. An average gradient can be multiplied by some constant. Instead of averaging the gradient, its logarithm can be averaged. In any case, the threshold is determined automatically based on the data computed in the first stage, rather than data specified by the user. In some embodiments, this algorithm may automatically adapt to image changes during animations, and may not require user input that is often difficult to provide since the user does not know which threshold is optimal in any given frame or situation. Thus, in some embodiments, a simple fixed primary pattern drives progressive, adaptive anti-aliasing. A measure, such as average gradient, is computed at initial sampling as an automatically computed threshold to shoot more samples in adaptive anti-aliasing.

Referring to FIG. 5, a processor-based system 130 may include a graphics processor 112. In one embodiment, the graphics processor 112 is a symmetric multiprocessing (SMP) processor, a vector processor, or a single instruction multiple data processor using four way of sixteen way data sets. In one embodiment, the graphics processor 112 may implement the sequence 10, shown in FIG. 1. It may do so using software, in one embodiment. However, in other embodiments, hardware or combinations of hardware and software, such as firmware, may be utilized. The graphics processor 112 may, itself, store the instructions for implementing a software based sequence 10, such instructions stored in a computer readable medium within the processor 112 or in a storage device or memory device, coupled to the processor 112. For example, the storage may be the main memory 132 and a sequence of instructions may be stored in the storage area 139 therein.

The graphics processor may work with a main processor or central processing unit 100. It some embodiments that use software implementations, the software could also be implemented in the main processor 100, but this may require transferring graphics data through buses which, in some embodiments, may slow execution. The graphics processor 112 and the main processor 100, in one embodiment, may be coupled by a bus 105 and the chipset core logic 110. The chipset core logic also interfaces with various storage, including the removable media 136, hard drives 134, and main memory 132.

The graphics pipeline includes not only the graphics processor 112, but also a frame buffer 114. The frame buffer 114 may be coupled through buses 106 and 107. A display screen 118 may be controlled by a bus 108 by a keyboard or mouse 120, in some embodiments.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
identifying an image region which is more likely to have aliasing effects than another region; and
taking more samples for anti-aliasing analysis in said region than said another region having less likelihood of aliasing.

2. The method of claim 1 including automatically determining a threshold such that if the likelihood of aliasing exceeds said threshold, taking additional samples.

3. The method of claim 2 including taking at least three samples per pixel in all the pixels of an image block.

4. The method of claim 3 including taking said samples at edges and corners of a pixel.

5. The method of claim 4 including taking additional samples wholly within the pixel in said image region where aliasing is more likely.

6. The method of claim 2 including stratifying a pixel into equal sized areas and taking one sample per equal sized area.

7. The method of claim 6 including combining two stratified patterns of samples to form a third pattern of samples so that the two stratified patterns contribute to the stratification of the third pattern.

8. The method of claim 2 including determining said threshold by finding the average illumination gradient between samples in adjacent sub-pixel areas.

9. The method of claim 2 including automatically computing whether said threshold is exceeded in said image region.

10. The method of claim 1 including using a primary sample density for all pixels and a secondary sample density for selected pixels having a higher likelihood of aliasing than other pixels.

11. The method of claim 1 including using either four or sixteen way sampling, depending on the width of a single instruction multiple data graphics processor.

12. The method of claim 1 including identifying said image regions in a 16-way ray tracing application.

13. An apparatus comprising:
a frame buffer; and
a graphics processor coupled to said frame buffer, said graphics processor to identify an image region more likely to have aliasing effects than another region and to take more samples for anti-aliasing analysis in said region than in said another region have less likelihood of aliasing.

14. The apparatus of claim 13, said processor to use a threshold to determine said image region relative to said another region.

15. The apparatus of claim 14, said processor to take said samples at pixel edges and corners.

16. The apparatus of claim 13 wherein said processor is a symmetric multiprocessing processor.

17. The apparatus of claim 13 wherein said processor is a single instruction multiple data processor.

18. The apparatus of claim 17 wherein said processor to group said samples into sets that correspond to the width of said single instruction multiple data processor.

19. The apparatus of claim 13, said apparatus to take a given number of primary samples per pixel in all the pixels in an image and to take a given number of additional samples in each pixel in said another region.

20. The apparatus of claim 19, said apparatus to stratify a pixel into equal sized areas and to take one sample per equal sized area.

21. The apparatus of claim 13 to automatically compute whether a threshold is exceeded that identifies said image region that is more likely to have aliasing.
